(19) United States
(12) Patent Application Publication
(10) Pub. No.: US 2006/0287949 A1
(43) Pub. Date: Dec. 21, 2006

(54) Debt collection system

(76) Inventor: Gary C. Silverman, San Clemente, CA (US)

Correspondence Address: STETINA BRUNDA GARRED & BRUCKER, 75 ENTERPRISE, SUITE 250, ALISO VIEJO, CA, 92656, US

(21) Appl. No.: 11/154,109

(22) Filed: Jun. 16, 2005

(51) Int. Cl. G06Q 40/00

(52) U.S. Cl. 705/39

(57) ABSTRACT

Improved methods, systems, and software are provided for facilitating debt collection by utilizing a non-term life insurance policy for making payments due by debtors to creditors. The life insurance policy can be implemented as, or in conjunction with, a sinking fund for maintaining premium payments received from a debtor under the policy. Periodic and/or lump sum payments to the creditor on behalf of the debtor can be made from the sinking fund, allowing the creditor to receive satisfaction of the debt. Various features can be implemented to provide for the entire amount of debt owed by the debtor to the creditor and further provide cash flow to the creditor after an initial period of contribution. In the event of death of the debtor, the creditor can receive full payment for the outstanding debt.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Field of Disclosure

The present disclosure is related to technology for facilitating debt collection.

2. Description of Related Art

In recent years, the widespread availability of easily obtainable credit has caused many consumers to become progressively more leveraged, taking on large amounts of debt relative to equity. As a result, millions of individuals find themselves without the necessary resources to pay their legal obligations to creditors. Such conditions can negatively impact the credit rating and state of mind of such individuals, as well as the ability of such persons to provide for themselves and their families.

Overleveraged conditions can also result in harmful effects experienced by creditors. In particular, many creditors can be adversely affected by an inability to collect on increasingly large amounts of bad debt. The financial impacts of these effects can be especially acute in the context of nonprofit or public health agencies, causing such agencies to become substantially hampered in their ability to provide needed services to the general population.

Current collection methods typically involve “the stick versus the carrot” approach in which a debt is assigned to a collection agency. The collection agency may badger and threaten the debtor to make monthly or periodic payments on the debt, often causing tremendous anxiety for the debtor and uncertainty for the creditor. If the debt is not paid off in a timely manner, legal proceedings may be initiated, oftentimes resulting in the filing of a bankruptcy wherein neither the debtor nor the creditor significantly benefits.

Various prior art approaches have been developed for addressing certain problems incident to debtor/creditor relationships. For example, Patent Publication No. US 2001/0047325 A1 to Livingston apparently discloses a method for providing lines of credit or loans to terminally ill individuals who have a qualified life insurance policy. The loans are secured by the policy.

U.S. Pat. No. 5,926,800 to Baronowski, et al. apparently discloses a system for providing loans to owners of life insurance policies who are terminally ill or aged wherein a statistical module, medical module, and financial module operate on a pre-selected group of inputs to yield a line of credit offered to the policyholder.

Patent Publication No. US 2004/0181436 A1 to Lange apparently discloses a method and system of charitable fundraising utilizing life insurance products wherein a nonprofit charitable organization holds life insurance policies of consenting donors and assigns the death benefits of the policies to a financial benefactor and acquires an ownership interest in the financial benefactor.

Patent Publication No. US 2004/0167807 A1 to Fitzsimmons, et al. apparently discloses a system and method for securitizing life insurance contracts to fund credit enhancements for borrowers and other community development activities. The system includes a collection component and a processing company. The collection component obtains insurance policy information and the processing company creates a special purpose vehicle for holding a plurality of life insurance contacts wherein each of the plurality of life insurance contracts is based on the insurance policy information from at least one eligible borrower.

Patent Publication No. US 2002/0035489 A1 to Herman, et al. apparently discloses a method and system for generating funds for a non-for-profit organization wherein a set of variable single premium universal life insurance policies are obtained from an insurer on a block of individuals. A re-insurer provides a mortality guarantee, and the life insurance premiums are invested to provide additional earnings.

Patent Publication No. US 2002/0091549 A1 to Provost, et al. apparently discloses a payment system for health care providers for rendered health care services.

Patent Publication No. US 2004/0176989 A1 to Darr apparently discloses a method for raising funds including taking out life insurance on insured interests of a first organization and naming the first organization as beneficiary of the life insurance. The method also includes transferring rights and the benefits from the life insurance on the insurable interests to at least a second organization to raise funds for at least the first organization or the second organization.

U.S. Pat. No. 5,966,693 to Burgess apparently discloses a method for administering a leveraged universal life insurance plan by use of a computer processing method to ensure lender security, accumulation of value to an employee, and minimum tax exposure.

U.S. Pat. No. 6,826,544 to Johnson apparently discloses an automated loan repayment system involving utilizing consumer payment authorization, clearing, and settlement systems to allow a merchant to reduce an outstanding loan amount.

Unfortunately, the above-identified prior art approaches to debtor/creditor relationships fail to provide useful alternatives to the classic carrot/stick predicament, while still providing satisfactory outcomes for both debtors and creditors. Accordingly, alternative approaches to collection efforts are needed to improve the quality and financial return incident to debtor/creditor relationships.

### BRIEF SUMMARY

The present disclosure provides improved methods, systems, and software for facilitating debt collection by utilizing a non-term life insurance policy for making payments due by debtors to creditors. The life insurance policy can be implemented as, or in conjunction with, a sinking fund for maintaining premium payments received from a debtor under the policy. Periodic and/or lump sum payments to the creditor on behalf of the debtor can be made from the sinking fund, allowing the creditor to receive satisfaction of the debt.

A system in accordance with various embodiments of the present disclosure can be implemented to provide for the entire amount of debt owed by the debtor to the creditor and further provide cash flow to the creditor after an initial period of contribution. For example, a debt collection system can be provided which allows a debtor to purchase a non-term life insurance contract, the dividends of which are paid over time to a creditor. In the event of death of the debtor, the creditor receives full payment for the outstanding debt.

In one embodiment, a method for providing debt collection services can detect a default condition applicable to a debtor in relation to a creditor. A life insurance policy can be provided to the debtor and premium payments can be received from the debtor pursuant to terms of the life insurance policy. The premium payments can be deposited into a sinking fund. A benefit payment can be provided from the fund to the creditor in satisfaction of the default condition.

In another embodiment, a system for providing debt collection services can comprise a plurality of components. A creditor component can be provided for detecting a default condition applicable to a debtor in relation to a creditor. An insurance provider component can provide a life insurance policy to the debtor, receive premium payments from the debtor pursuant to terms of the life insurance policy, and deposit the premium payments. A sinking fund component can receive the premium payments from the insurance provider component and provide benefit payments from the deposited premium payments to the creditor in at least partial satisfaction of the default condition.

These as well as other embodiments contemplated by the present disclosure will be more fully set forth in the detailed description below and the figures submitted herewith.

### BRIEF DESCRIPTION OF THE DRAWINGS

FIG. 1 is a block diagram illustrating relationships between a plurality of entities participating in a debt collection process in accordance with an embodiment of the present disclosure;

FIG. 2 is a block diagram illustrating a debt collection system in accordance with an embodiment of the present disclosure; and

FIG. 3 is a flowchart describing a process for providing debt collection services in accordance with an embodiment of the present disclosure.

### DETAILED DESCRIPTION

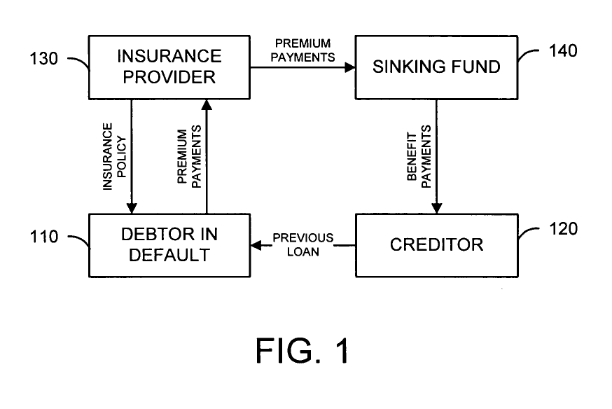

Referring now to the figures wherein the showings are for purposes of illustrating embodiments of the present disclosure only, and not for purposes of limiting the same, FIG. 1 is a block diagram illustrating relationships between a plurality of entities participating in a debt collection process in accordance with an embodiment of the present disclosure.

As illustrated, a pre-existing debtor/creditor relationship can exist between a debtor 110 and creditor 120. Such a relationship could arise from a loan previously made by creditor 120 to debtor 110 pursuant to a loan agreement or other contract between the parties. In the course of the repayment period of the loan, a default condition may occur which places the debtor 110 in default in relation to the loan. Such a default condition may result from a variety of occurrences, such as the failure of the debtor 110 to make a required payment under the loan, the failure of the debtor 110 to satisfy a condition for the loan, and/or other a failure of one or more other obligations of the debtor 110 which may be related to the loan.

Upon the detection of one or more default conditions, the creditor 120 may choose to offer a repayment plan to the debtor 110 in accordance with an embodiment of the present disclosure. Debtor 110 enrollment in the plan could be facilitated by initial telephone-based marketing efforts followed by enrollment through a website. Under such a repayment plan, the debtor 110 applies for a suitable life insurance policy available from insurance provider 130 having terms acceptable to creditor 120. Once approved, the life insurance policy is provided to the debtor 110 by the insurance provider 130. Thereafter, premium payments required under the insurance policy are paid by the debtor 110 to the insurance provider 130, or any appropriate receiving authority specified by the insurance policy.

It will be appreciated that insurance provider 130 discussed herein can be an insurance company or any entity capable of providing and/or underwriting a life insurance policy in accordance with the various embodiments contemplated herein. For example, guaranteed issue group underwriting could be provided by insurance companies up to a maximum amount. It will also be appreciated that the life insurance policy may be provided by creditor 120 rather than a separate insurance provider 130. It will further be appreciated that in such cases, communications and steps described herein with regard to the insurance provider 130 can be applied to creditor 120.

In various embodiments, the life insurance policy may be implemented as a guaranteed issue, non-term life insurance policy, such as whole life insurance, universal life insurance, limited-pay life insurance, endowments, and/or other appropriate types of permanent life insurance. Alternatively, other financial instruments offering guaranteed payments and/or death benefits, such as annuities or other financial instruments, may be substituted for the life insurance policy where appropriate. Premium payments made by the debtor under the insurance policy or other financial instrument can be implemented to correspond to manageable amounts which the debtor will not have difficulty paying. For example, in at least one embodiment, such payments could comprise approximately 2%-5% of the amount of the debtor's outstanding debt per year, and can vary with the age of the debtor.

It will be appreciated that the life insurance policy can be underwritten and issued in different ways, with various associated benefits. For example, with simplified underwriting, the debtor 110 can be asked a minimum number of questions, thereby facilitating rapid issuance of the policy. Using group underwriting, the risks associated with the issuance of the policy can be reduced due to the size of the insured group, thereby increasing the likelihood that the debtor 110 will qualify for the policy. With full underwriting, the policy can vary on the size of the death benefit associated with the policy.

Premium payments received from the debtor 110 under the insurance policy can be maintained by the insurance provider 130 and/or deposited into a sinking fund 140 where they are permitted to grow over time. Typically, the sinking fund 140 can be maintained by the insurance provider 130, but alternatively can be maintained by creditor 120 and/or any appropriate entity.

Benefit payments can be made from the sinking fund 140 to the creditor 120 pursuant to the terms of the insurance policy. Typically, such benefit payments can comprise some or all of the cash value of the life insurance policy which is paid upon the death of the debtor 110, thereby satisfying the existing default condition and repaying the outstanding debt. The policy values, premium payments, and benefit payments can be configured such that the benefit payments under the policy are self-completing for the entire amount of debt owed by the debtor 110.

Other types of benefit payments may also be provided pursuant to other terms of the insurance policy such as dividends, interest, surrender value, and/or other benefit payments made during and/or after the pendency of the policy. Benefit payments payable during the pendency of the policy may also be reinvested in the sinking fund 140 and paid upon the occurrence of a subsequent event, such as the death of the debtor 110, the sinking fund 140 growing to a sufficient amount to pay the outstanding debt and any applicable interest in full, and/or other events.

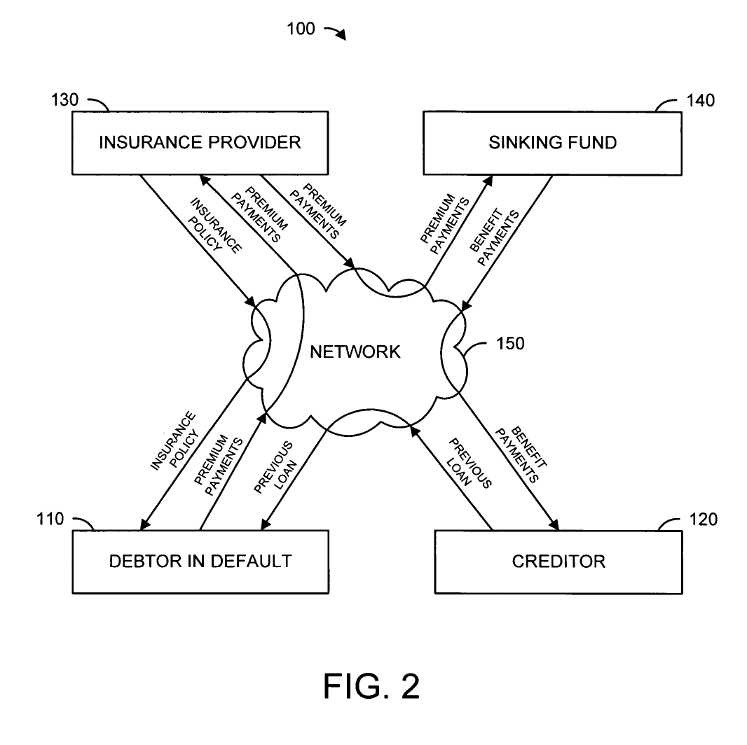

FIG. 2 is a block diagram illustrating a debt collection system 100 in accordance with an embodiment of the present disclosure. It will be appreciated that the various entities identified in FIG. 1 above are further represented in FIG. 2 as communicating over a network 150 in accordance with a debt collection system 100.

Each of the entities 110 through 140 can be provided with appropriate computing devices comprising components of system 100 to facilitate communication and performance of various steps and processes described herein over one or more networks 150. Network 150 can be implemented in accordance with any appropriate networking technology, including but not limited to: the Internet, intranets, landline networks, wireless networks, and/or other network technologies known in the art.

As illustrated in FIG. 2, the various communications and relationships previously described with respect to FIG. 1 can be realized in electronic form in FIG. 2 by the various components of system 100 communicating with each other through network 150. For example, the system 100 could be configured to allow for the enrollment and administration of various processes for providing debt collection services through communication with various websites over the Internet. It will further be appreciated that one or more components of system 100 can be implemented in accordance with direct and/or non-networked communication methods in addition to, or in the alternative to, network 150.

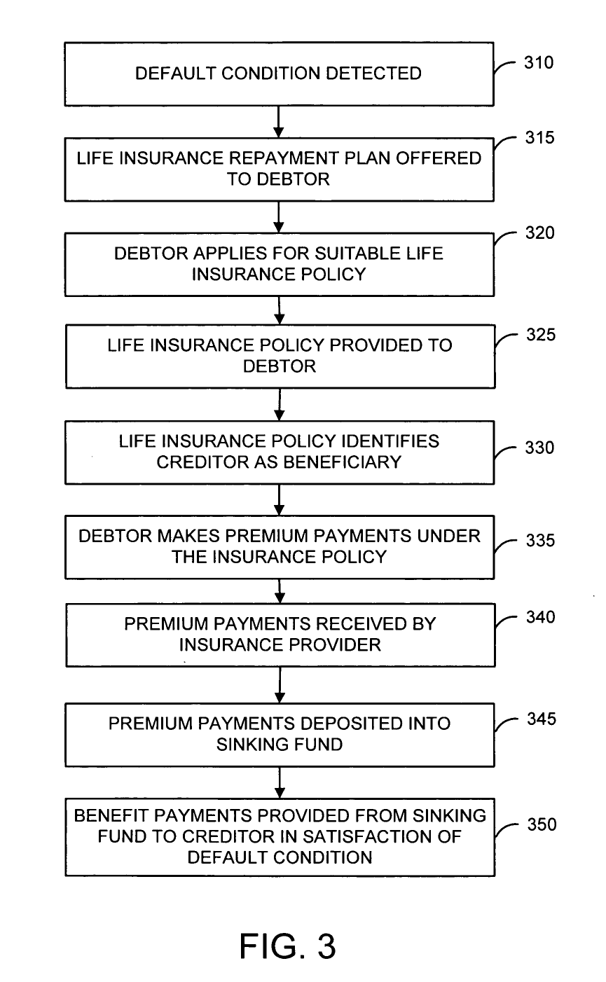

FIG. 3 is a flowchart describing a process for providing debt collection services in accordance with an embodiment of the present disclosure. As a preliminary step, a default condition is detected (step 310). As discussed, such conditions typically can be detected by creditor 120 through the occurrence of an action (for example, a missed payment) that triggers a default by the debtor 110 pursuant to the terms of a preexisting debtor/creditor relationship, such as a loan. The default condition may be detected by creditor 120 through a creditor component of system 100 maintained by creditor 120 for monitoring its relationships with debtors 110.

Once the default condition is detected, the creditor 120 may offer to the debtor 110 an alternative repayment plan in accordance with one or more of the debt collection methods described herein utilizing a non-term life insurance policy (step 315). If the debtor 110 agrees to the repayment plan, then the debtor 110 can apply for a suitable life insurance policy that meets any minimum conditions required by the creditor 120 under the repayment plan (step 320). If the debtor's 110 application is approved, then the debtor 110 is enrolled in the policy and the requested life insurance policy is provided to the debtor 110 (step 325). Pursuant to the repayment plan, the creditor 120 can be identified as the beneficiary of benefit payments to be made under the policy (step 330).

The debtor 110 then proceeds to make premium payments to the insurance provider 130 pursuant to the terms of the life insurance policy (step 335). The premium payments received by the insurance provider 130 (step 340) can be deposited into a sinking fund 140 (step 345).

Benefit payments can then be provided from the sinking fund 140 to the creditor 120 pursuant to the terms of the insurance policy to satisfy the default condition (step 350). As discussed, such benefit payments can be made upon the death of the debtor 110, but may also be made pursuant to other terms of the insurance policy. In various embodiments, benefit payments to the creditor 120 can be made periodically and/or in a lump sum, depending on the agreed-upon terms of the insurance policy and repayment plan.

In view of the present disclosure, it will be appreciated that various embodiments of the debt collection system and related methods provided herein can provide significant benefits. The debtor's 110 participation in a repayment plan as contemplated herein can create a sense of self esteem for the debtor 110, allowing the debtor 110 to satisfy existing credit obligations in a manageable way. The debtor's 110 compliance with such a repayment plan may also allow for the removal of a negative credit rating associated with the debtor 110, resulting in the debtor's 110 improved creditworthiness as perceived by other potential creditors and/or other entities. In addition, for creditor/debtor relationships to which nonprofit entities are parties (for example, nonprofit corporations), the use of a foundation trust for the sinking fund 140 may allow premium payments to be handled as deductible for tax purposes.

It will be appreciated that features of the present disclosure can be beneficially employed by creditors in a wide range of industries such as hospitals, health care facilities, credit card companies, financial institutions, taxing authorities, and/or others. In addition, it will be appreciated that various debt collection features described herein can be used in conjunction with and/or in the alternative to other types of debt collection. For example, the use of non-term life insurance in the various manners disclosed herein could be used as a “last resort” alternative after a creditor 120 has found other forms of debt collection to be ineffective. Alternatively, the use of non-term life insurance could also be employed as the primary form of debt collection utilized by the creditor 120.

Where applicable, various embodiments of the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be dissected into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can stored on one or more computer readable mediums. It is also contemplated that software identified herein can be implemented using one or more general purpose or specific purpose computers and/or computer systems, networked and/or otherwise.

Where applicable, the ordering of various steps described herein can be changed, combined into composite steps, and/or dissected into sub-steps to provide the functionality described herein.

The foregoing disclosure is not intended to limit the present disclosure to the precise forms or particular fields of use disclosed. It is contemplated that various alternate embodiments and/or modifications to the present disclosure, whether explicitly described or implied herein, are possible in light of the disclosure. Further, the various features of the embodiments disclosed herein can be used alone, or in varying combinations with each other and are not intended to be limited to the specific combinations described herein.

It will be appreciated that features of the present disclosure can be applied in the context of loan-based creditor/debtor relationships between institutional lenders and borrowers, such as mortgages, student loans, automobile loans, government-backed loan programs, and other loan-based relationships. However, it will also be appreciated that various aspects of the present disclosure can be advantageously applied to other types of creditor/debtor relationships, where appropriate.

For example, in the context of a proactive lending contracts, a lender may first look to collateral of a debtor to satisfy a debt, subject to the terms of a preloan agreement between the lender and debtor. If the collateral is insufficient to satisfy the debt, then the remainder of the debt can be satisfied by an appropriate insurance policy as disclosed herein.

Principles disclosed herein can also be applied in the context of default settlements and viaticals in order to accelerate partial and/or full payment of a debt. For example, an appropriate life insurance policy of a debtor can be sold at a discount in satisfaction of a debt owed to a creditor.

In the field of health care, medical patient debtor premium payments for an appropriate life insurance policy could be paid to a foundation or other charitable entity, potentially making such payments deductible for tax purposes.

Principles disclosed herein can also be used to provide an appropriate life insurance policy as part of an offer and compromise settlement between a taxing authority and a taxpayer with an outstanding tax debt. Such applications may allow existing liens to be removed relative to the debtor, providing the debtor with greater financial freedom and potentially better credit ratings, and potentially allowing the debtor's assets to avoid probate proceedings.

In the context of bankruptcy, an appropriate life insurance policy of a debtor can be provided to a bankruptcy trustee and in turn provided to creditors in satisfaction of debts owed by the debtor. It is contemplated that principles disclosed herein can also be applied to other types of creditor/debtor relationships and/or credit arrangements, where appropriate.

What is claimed is:

1. A method for providing debt collection services, the method comprising:
detecting a default condition applicable to a debtor in relation to a creditor;
providing a life insurance policy to the debtor;
receiving a premium payment from the debtor pursuant to terms of the life insurance policy;
depositing the premium payment into a sinking fund; and
providing a benefit payment from the fund to the creditor in satisfaction of the default condition.

2. The method of claim 1, the life insurance policy is a non-term life insurance policy.

3. The method of claim 2, the life insurance policy is a guaranteed issue life insurance policy.

4. The method of claim 3, the life insurance policy is a whole life insurance policy.

5. The method of claim 2, the life insurance policy is subject to simplified underwriting.

6. The method of claim 2, the life insurance policy is subject to group underwriting.

7. The method of claim 2, the life insurance policy is subject to full underwriting.

8. The method of claim 1, further comprising:
utilizing a guaranteed annuity in place of the life insurance policy.

9. The method of claim 1, the default condition is a default on a student loan.

10. The method of claim 1, the benefit payment is made upon death of the debtor.

11. The method of claim 1, further comprising:
in place of the receiving step, receiving a plurality of premium payments from the debtor pursuant to terms of the life insurance policy;
in place of the depositing step, depositing the premium payments into a sinking fund; and
in place of the second providing step, providing benefit payments from the fund to the creditor in satisfaction of the default condition.

12. The method of claim 11, the benefit payments are made periodically during the pendency of the life insurance policy.

13. The method of claim 1, the method is performed over a computer network.

14. The method of claim 13, the network is the Internet.

15. A system for providing debt collection services, the system comprising:
a creditor component for detecting a default condition applicable to a debtor in relation to a creditor;
an insurance provider component for providing a life insurance policy to the debtor, receiving premium payments from the debtor pursuant to terms of the life insurance policy, and depositing the premium payments; and
a sinking fund component for receiving the premium payments from the insurance provider component and providing benefit payments from the deposited premium payments to the creditor in at least partial satisfaction of the default condition.

16. The system of claim 15, the life insurance policy is a non-term life insurance policy.

17. The system of claim 16, the life insurance policy is a guaranteed issue life insurance policy.

18. The system of claim 17, the life insurance policy is a whole life insurance policy.

19. The system of claim 16, the life insurance policy is subject to simplified underwriting.

20. The system of claim 16, the life insurance policy is subject to group underwriting.

21. The system of claim 16, the life insurance policy is subject to full underwriting.

22. The system of claim 15, a guaranteed annuity is utilized in place of the life insurance policy.

23. The system of claim 15, the default condition is a default on a student loan.

24. The system of claim 15, the benefit payments are made upon death of the debtor.

25. The system of claim 15, the benefit payments are made periodically during the pendency of the life insurance policy.

26. The system of claim 15, the components being in communication over a computer network.

27. The system of claim 26, the network is the Internet.

28. A computer readable medium with software embodied therein, the software operable to perform a method for providing debt collection services when run by a computing system, the method comprising the steps of:
detecting a default condition applicable to a debtor in relation to a creditor;
providing a life insurance policy to the debtor;
receiving premium payments from the debtor pursuant to terms of the life insurance policy;
depositing the premium payments into a sinking fund; and
providing benefit payments from the fund to the creditor in satisfaction of the default condition.

29. The computer readable medium of claim 28, the computing system comprising:
a creditor component for performing the detecting step;
an insurance provider component for performing the receiving, depositing, and first providing steps; and
a sinking fund component for performing the second providing step.

30. The computer readable medium of claim 29, the components being in communication over a computer network.
